(19) United States
(12) Patent Application Publication
(10) Pub. No.: US 2024/0139649 A1
(43) Pub. Date: May 2, 2024

(54) ALCOHOL SOLVENT RECOVERY FOR OLEAGINOUS MATERIAL EXTRACTION

(71) Applicant: Crown Iron Works Company, Blaine, MN (US)

(72) Inventors: Wade Steven Martinson, Minneapolis, MN (US); Benjamin Wayne Floan, Andover, MN (US); Nicholas Ollila, Fridley, MN (US); Jeff Garritsen, Forest Lake, MN (US); Austin Nelson, Maple Grove, MN (US)

(21) Appl. No.: 18/547,914

(22) PCT Filed: Feb. 25, 2022
(86) PCT No.: PCT/US2022/017965

§ 371 Date: Aug. 25, 2023

Related U.S. Application Data
(60) Provisional application No. 63/153,449, filed on Feb. 25, 2021.

(51) Int. Cl. B01D 11/02

(52) U.S. Cl. CPC B01D 11/0288; B01D 11/028; B01D 11/0292

(57) ABSTRACT

Devices, systems, and techniques can be provided for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may be ethanol. A concentration of oil in the feedstock may decrease as the feedstock moves through the extractor from the inlet to the outlet while the concentration of the oil in the solvent increases.

### RELATED APPLICATION

This Application claims priority to U.S. Provisional Patent Application No. 63/153,449 filed Feb. 25, 2021 the entire contents of which are incorporated herein by reference.

### TECHNICAL FIELD

This disclosure relates to solvent extraction and, more particularly to liquid-solvent extraction using an alcohol-based solvent.

### BACKGROUND

A variety of different industries use extractors to extract and recover liquid substances entrained within solids. For example, producers of oil from renewable organic sources use extractors to extract oil from oleaginous matter, such as soybeans, rapeseed, sunflower seed, peanuts, cottonseed, palm kernels, and corn germ. The oleaginous matter is contacted with an organic solvent within the extractor, causing the oil to be extracted from a surrounding cellular structure into the organic solvent. As another example, extractors are used to recover oil from oil sands and other petroleum-rich materials. Typically, the petroleum-rich material is ground into small particles and then passed through an extractor to extract the oil from the solid material into a surrounding organic solvent.

During operation, the selected feedstock is passed through the extractor and contacted with a solvent. The solvent can extract oil out of the feedstock to produce an oil deficient solids discharge and a miscella stream. The miscella stream can contain the solvent used for extraction and oil extracted from the feedstock.

In practice, solvents such as hexane are typically used for extracting oil from oleaginous materials. The oil and/or extracted solid can be used as an intermediate or end product for human and/or animal consumption. While the solvent is removed from the oil and/or extracted solid prior to consumption, consumers are increasingly sensitive about food production processes and standards. Ethanol is alternative solvent to hexane that can be used to separate oil from various oleaginous materials. Ethanol is GRAS (Generally Recognized As Safe), can be produced organically, including from renewable feedstocks, and is already accepted by the consuming public as a component of alcoholic beverages.

### SUMMARY

In general, this disclosure is directed to devices, systems, and techniques, for processing an oil-containing material with an alcohol-based solvent to extract oil from the material. In some examples, a system includes an extractor configured to process an oil-containing feedstock. The extractor receives the oil-containing feedstock and conveys the material from an inlet to an outlet through the extractor. The extractor also receives an alcohol-based solvent at a solvent inlet and conveys the solvent through the extractor to a solvent outlet. The alcohol-based solvent may travel in a countercurrent direction through the extractor from a direction of material travel that the feedstock travels through the extractor. In either case, a concentration of oil in the feedstock may decrease as the feedstock moves through the extractor from the inlet to the outlet. Similarly, the concentration of oil in the solvent may increase as the solvent moves through the extractor from the solvent inlet to the solvent outlet.

In accordance with some implementations of the present disclosure, an extractor system may utilize various hardware configurations and processing techniques specifically facilitated by the use of an alcohol-based solvent. The systems and techniques may leverage the processing characteristics and properties of the alcohol-based solvent to efficiently and economically process an oil-containing feedstock utilizing the solvent. While any suitable alcohol-based solvent can be used in the systems and techniques of the disclosure, in some implementations, ethanol is used as the solvent. The ethanol solvent may be hydrous ethanol or anhydrous ethanol. For example, the solvent may contain greater than 90 weight percent ethanol, such as greater than 95 weight percent ethanol, or greater than 98 weight percent ethanol.

While a variety of different solid feedstock materials may be extracted and processed using an alcohol solvent, soybeans are one of the most common feedstocks commercially processed to extract vegetable oil and provide extracted soybean meal. Soybeans contain several anti-nutritional factors (ANFs) such as a trypsin inhibitor, which can interfere with digestion and nutritional uptake. For these reasons, some ANFs of nutritional significance may be deactivated (e.g., destroyed) during processing. In a traditional hexane solvent extraction process, for example, soy material having undergone extraction may be processed in a desolventizer-toaster. Steam and thermal energy may be supplied in the desolventizer-toaster to vaporize solvent from the solvent-wet solid material, both desolventizing the material and deactivating certain ANFs present in the material. Yet when using an alcohol-based solvent such as ethanol instead of hexane, an azeotropic mixture forms when water (e.g., steam) is added to the solvent. This makes solvent recovery challenging.

In some implementations of the present disclosure, however, systems and techniques are described that destroy and/or deactivate certain ANFs present in the solid material being processed and facilitate solvent recovery while minimizing or eliminating the addition of water (e.g., steam) to the solvent-wet material, such as added steam used in a traditional desolventizer-toaster. In some examples, separate processes are performed on the solid material to treat ANFs and to desolventize the material. Accordingly, the ANF treatment process and the desolventization processes can occur under different moisture conditions, which may or may not involve introducing steam to the solid material during ANF treatment but desolventizing in the absence of added steam.

In one example, for instance, a method of treating a soy material may involve pretreating a soy material containing an ANF to deactivate the ANF prior to performing solvent extraction on the material. Pretreatment may involve heating the soy material under controlled humidity, which may or may not include adding water (e.g., steam) to the material. In some implementations, the material is subsequently dried to remove residual moisture and solvent extraction is performed on the material using an alcohol solvent. The resulting solvent-wet extracted soy material can then be desolventized, e.g., via heating without steam injection or with limited steam injection.

In another example, a method of pretreating a soy material containing an ANF may involve initially performing a solvent extraction on the material using an alcohol solvent. The resulting solvent-wet extracted soy material can then be desolventized, e.g., via heating without steam injection or with limited steam injection, to produce a desolventized extracted soy material. The desolventized extracted soy material can then be processed to deactivate an ANF present in the desolventized extracted soy material, e.g., via heating under controlled humidity conditions, optionally with injection of steam.

A variety of different extraction system configurations and processing techniques can be implemented according to the disclosure in addition to or in lieu of those implemented for treating ANFs. For example, various systems and techniques can be implemented to help efficiently separate and recover solvent from a miscella stream generated during extraction. In operation, an extraction system can utilize an extractor to generate an oil-containing solvent stream called a miscella and an oil-deficient solids stream carrying entrained solvent called a marc. To separate the oil from the solvent in the miscella stream, the miscella stream may be cooled to a temperature effective to cause phase separation between the aqueous solvent and the oil in the stream. The solvent-rich layer and the oil-rich layer formed via cooling can then be separated, e.g., using a decanter. This can produce a separated oil-rich stream and a separated solvent-rich stream. In some implementations, the separated solvent-rich stream may be further processed to remove residual oil in the stream. For example, a comparatively small amount of water may be added to the stream to promote flocculation and further phase separation between the aqueous and oil components of the stream. Addition of water to the solvent stream may generate a second phase separation, forming a solvent-rich layer and an oil-rich layer. This oil-rich layer formed via the addition of the water can then be separated, e.g., using a second decanter. Other types of separation processes may be performed on the solvent-rich stream in addition to or in lieu of adding water and performing a second phase separation.

In addition to or in lieu of performing multiple separation steps on the miscella stream generated by the extractor, an extraction system may include one or more recycle streams to recycle solvent recovered from the miscella stream back to the extractor. For example, after phase separating solvent from the miscella stream using one or more separation (e.g., decanting) steps, the residual oil stream may be thermally separated (e.g., via stripping) to produce a finished oil stream and a thermally separated solvent stream substantially devoid of oil. This thermally separated solvent stream may or may not be combined with a thermally separated solvent stream produced by vaporizing solvent from the solvent-wet processed solid material discharge from the extractor. In either case, the solvent may be recycled to the inlet of the extractor where fresh, makeup solvent is also introduced to the extractor.

In some applications, an extractor system according to disclosure may utilize a solvent recycle stream that recycles solvent from a separator and/or a second separator back to the extractor, where the recycled solvent is introduced into the extractor at a location different than the location where fresh (and/or recycled solvent substantially devoid of oil) is recycled back to the extractor. For example, in a multistage extractor, a solvent stream produced from a first separation process and/or a second separation process may be recycled back to the extractor and introduced into the extractor at an earlier extraction stage than an extraction stage where fresh solvent is introduced into the extractor. The solvent stream may be recycled back to the extractor and introduced into the extractor at location where a composition of miscella in the extractor is substantially the same as a composition of the solvent stream (which also contains residual oil). Recycling the solvent stream produced by the separator back to the extractor without fully purifying the stream (e.g., performing thermal separation to thermally remove residual oil from the solvent) may provide a more efficient and economical process then purifying the separated stream and recycling the purified solvent back to the fresh solvent inlet.

In one example, a method is described that includes pretreating a soy material containing a trypsin inhibitor to deactivate the trypsin inhibitor, thereby forming a pretreated soy material. The method involves conveying the pretreated soy material in a conveyance direction through an extractor and conveying a solvent comprising alcohol in a countercurrent direction from the conveyance direction through the extractor, thereby generating an extracted soy material stream and a miscella stream. The method further includes separating the solvent from the miscella stream, thereby forming an extracted oil stream, and desolventizing the extracted soy material stream, thereby formed a dried extracted soy material stream.

In another example, a method is described that includes conveying a soy material in a conveyance direction through an extractor and conveying a solvent comprising alcohol in a countercurrent direction from the conveyance direction through the extractor, thereby generating an extracted soy material stream and a miscella stream. The method involves separating the solvent from the miscella stream, thereby forming an extracted oil stream and an extracted soy material stream. The method includes desolventizing the extracted soy material stream in an absence of added moisture during desolventizing, thereby forming a recovered solvent stream and a desolventized extracted soy material. The method further includes deactivating a trypsin inhibitor in the desolventized extracted soy material.

In another example, a method is described that includes conveying a material to be processed in a conveyance direction through an extractor and conveying a solvent comprising alcohol in a countercurrent direction from the conveyance direction through the extractor, thereby generating an extracted material stream and a miscella stream. The method includes cooling the miscella stream to form a first solvent-rich layer phase separated from a first oil-rich layer and separating the first solvent-rich layer from the first oil-rich layer to form a first separated oil-rich stream and a first separated solvent-rich stream. The method also includes performing a secondary separation on the first separated solvent-rich stream to form a separated solvent stream and a second separated oil-rich stream and recycling the separated solvent stream back to the extractor.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example extraction system in which a solid material is pretreated prior to extraction.

FIG. 2 is a block diagram illustrating another example extraction system in which an extracted solid material is desolventized prior to deactivating one or more ANFs of interest.

FIG. 3 is a block diagram illustrating an example extraction system in which a miscella stream is processed for solvent recovery.

FIG. 4 is an illustration of an example extractor configuration that can be used in the systems of FIGS. 1-3.

### DETAILED DESCRIPTION

In general, the disclosure relates to liquid-solid extractor systems and processes that enable the extraction of one or more desire products from solid material flows. In some examples, the solid material is processed in a continuous flow extractor that conveys a continuous flow of material from its inlet to its outlet while a solvent is conveyed in a countercurrent direction from a solvent inlet to a solvent outlet. As the solvent is conveyed from its inlet to its outlet, the concentration of extracted liquid relative to solvent increases from a relatively small extract-to-solvent ratio to a comparatively large extract-to-solvent ratio. Similarly, as the solid material is conveyed in the opposing direction, the concentration of extract in the solid feedstock decreases from a comparatively high concentration at the inlet to a comparatively low concentration at the outlet. The amount of time the solid material remains in contact with the solvent within the extractor (which may also be referred to as residence time) can vary, for example depending on the material being processed and the operating characteristics of the extractor, although will typically be within the range of 15 minutes to 3 hours, such as from 1 hour to 2 hours.

The solvent discharged from the extractor, which may be referred to as a miscella, contains extracted components (e.g., oil, carbohydrates, sugars) from the solid feedstock. The solvent-wet solid material discharged from the extractor may be residual solid feedstock having undergone extraction. In some configurations according to the present disclosure, systems and techniques are described that destroy and/or deactivate certain anti-nutritional factors (ANFs) such as trypsin present in the solid material being processed and facilitate solvent recovery while minimizing or eliminating the addition of water (e.g., steam) to the solvent-wet material. For example, the ANF may be deactivated through application of heat and/or controlled humidity in a deactivation process separate from a drying process in which the solvent-wet solid material is heated to vaporize entrained solvent. This can allow different moisture conditions in the ANF deactivation step as compared to the desolventization step. Controlling the amount of moisture in the solvent and/or solid material can be useful, e.g., to help prevent formation of an azeotropic solvent mixture that can inhibit efficient solvent recovery during desolventization.

Additionally or alternatively, in some configurations according to the present disclosure, a miscella stream produced from an extractor is processed to separate the solvent present in the miscella stream from the oil present in the miscella stream. In one configuration, for example, the miscella stream is received from the extractor and cooled to a temperature effective to cause liquid-liquid phase separation between the aqueous and oil components of the miscella stream. For example, the miscella stream may be cooled to a temperature low enough to cause liquid-liquid phase separation but high enough to substantially prevent solidification of either the aqueous or oil components in the stream. In either case, the phase-separated aqueous and oil components of the miscella stream can be separated for further processing and/or recycle, as described herein.

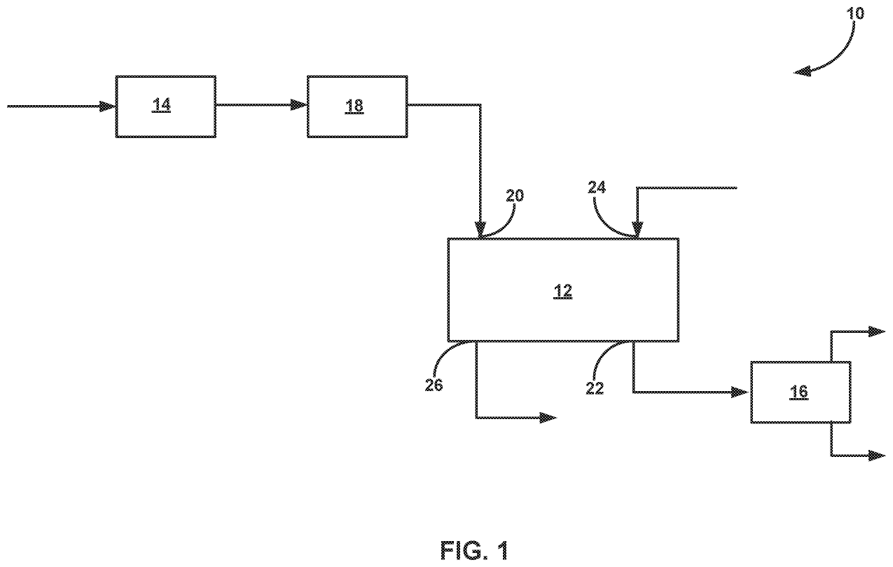

FIG. 1 is a block diagram illustrating an example extraction system 10 according to the disclosure in which a solid material is pretreated prior to extraction. System 10 includes an extractor 12, a pretreatment unit 14, and a desolventizer 16. System 10 is also illustrated as including a dryer 18 upstream of extractor 12. Extractor 12 has a feed inlet 20 that can receive a solid material after having undergone pretreatment in pretreatment in vessel 16 and optional drying in dryer 18 to be subject to extraction within the extractor. Extractor 12 also has a feed outlet 22 that can discharge the solid particulate material after is has undergone extraction and has a lower concentration of extract than the fresh incoming material. Extractor 12 also has a solvent inlet 24 configured to introduce fresh solvent into the extractor and a solvent outlet 26 configured to discharge a miscella formed via extraction of extractable components from the solid material.

In operation, the solid material being processed is contacted with solvent within extractor 12 (e.g., in counter current fashion), causing components soluble within the solvent to be extracted from the solid material into the solvent. Extractor 12 can process any desired solid material using any suitable extraction fluid. Example types of solid material that can be processed using extractor 12 include, but are not limited to, oleaginous matter, such as soybeans, rapeseed, sunflower seed, peanuts, cottonseed, palm kernels, and corn germ; oil-bearing seeds and fruits; asphalt-containing materials (e.g., asphalt-containing roofing shingles that include an aggregate material such as crushed mineral rock, asphalt, and a fiber reinforcing); alfalfa; almond hulls; anchovy meals; bark; coffee beans and/or grounds, carrots; chicken parts; diatomic pellets; fish meal; hops; oats; pine needles; tar sands; vanilla; and wood chips and/or pulp.

In some examples, the solid material processed in extractor 12 includes one or more anti-nutritional factors (ANFs). Example ANFs that may be present in the material include trypsin inhibitor, lectins, glycinin, beta-conglycinin, oligosaccharides, and combinations thereof. For example, one or more of these ANFs may be found in soy material (e.g., soy beans, which may or may not have undergone further processing such as size reduction). For example, a common ANF of interest when extracting soy material to produce soy meal is trypsin inhibitor. Trypsin inhibitor is a protease inhibitor that can inhibits the activity of enzymes that digest protein in the digestive tract such as trypsin, chymotrypsin and the like. Example concentrations of trypsin inhibitor that may be found in the solid material (e.g., soy material) prior deactivation range from 1.8 mg per gram of material to 50.0 mg per gram of material.

Alcohol-based solvents that can be used for extraction from solid material include, but are not limited to, mono-hydroxyl or multi-hydroxyl (e.g., di-hydroxyl) alcohols having carbon chains 1 to 8 carbons in length, such as 1 to 4 carbons in length, or 2 to 3 carbons in length. For example, the alcohol-based solvent may be ethanol or isopropyl alcohol. In some examples, the alcohol-based solvent consists essentially of alcohol (e.g., with or without water). For example, the alcohol-based solvent may be a hydrous alcohol or an anhydrous alcohol solvent. In some examples, the alcohol-based solvent has greater than 90 weight percent alcohol and less than 10 weight percent water, such as greater than 95 weight percent alcohol and less than 5 weight percent water, or greater than 98 weight percent alcohol and less than 5 weight percent water.

In the example of FIG. 1, the solid material to be extracted with an alcohol-based solvent in extractor 12 is first processed in pretreatment unit 14 to deactivate one or more ANFs, such as a trypsin inhibitor. Pretreatment unit 14 may be composed of one or more vessels that subject the incoming solid material to a treatment effective to substantially completely deactivate all of one or more ANFs of interest. Each such vessel may operate with a continuous flow of solid material entering and exiting the vessel, in batch mode where a fixed volume of solid material enters the vessel and is held for a period of time before being discharged, and/or semi-batch mode.

In any case, the solid material may be treated to substantially completely deactivate all of one or more ANFs of interest in the incoming solvent material, such as deactivate at least 95% of one or more ANFs of interest in the incoming material, at least 98% of one or more ANFs of interest, at least 99% of one or more ANFs of interest, at least 99.5% of one or more ANFs of interest, or at least 99.9% of one or more ANFs of interest. Each of the foregoing deactivation percentages may be measured on a weight basis by comparing the weight concentration (e.g., mg/g) of one or more ANFs of interest in the incoming solid material to that of the treated material discharged from pretreatment unit 14. The one or more ANFs of interest may be a trypsin inhibitor and/or one or more other ANFs of interest. An ANF may be deactivated in that the molecular structure of the ANF may be modified and/or destroyed so as to inhibit or eliminate the anti-nutritional functionality of the ANF.

Pretreatment unit 14 can be configured to deactivate one or more ANFs in a number of different ways. In some examples, pretreatment unit 14 treats the solid material with an energy source, such as gamma radiation or ultrasound, to deactivate one or more ANFs in the sample. Additionally or alternatively, pretreatment unit 14 may apply chemical treatment to the solid material to deactivate one or more ANFs.

In general, chemical treatments are based on the use of substances that have the capacity of altering molecular structures through chemical interactions. In the particular case of trypsin inhibitors, the main target of chemical treatments is typically to disrupt disulfide bonds that give structure and stability to the trypsin inhibitor tertiary structure. As an example treatment, pretreatment unit 14 may thermally treat the solid material in the presence of a base (e.g., sodium hydroxide, ammonium hydroxide, sodium bicarbonate) to deactivate one or more ANFs. This treatment can function since extremely high or low pHs promote loss of enzyme activity due to unfavorable electrostatic interactions between amino acid residues which cause conformational changes in the active site. Reducing agents are known to inactivate trypsin inhibitors via the disruption of disulfide bonds.

In addition to or in lieu of any of the foregoing treatment techniques, pretreatment unit 14 may thermally treat the solid material to deactivate one or more ANFs. The processing can inactivate thermolabile ANFs, such as trypsin inhibitors, e.g., by promoting the breakage of intermolecular bonds responsible of holding the tertiary structure of the trypsin inhibitors. The extent of the thermal processing needed to be performed on the solid material to deactivate substantially all of one or more ANFs of interest may vary depending on a variety of factors, such as the specific one or more ANFs targeted for deactivation, the humidity (moisture) conditions of the solid material being thermally treated, and/or the thermal stability of the solid material being processed.

In some examples, pretreatment unit 14 includes one or more vessels that heat the solid material being processed at a controlled humidity. For example, pretreatment unit 14 may include a vessel that is pressure isolated from the ambient or surrounding environment, e.g., via an airlock, rotary valve, or other structure that allows solid material to enter and exit the vessel on a continuous or batch basis while substantially isolating the gaseous environment inside of the vessel from the gaseous environment outside of the vessel. The material inside of the vessel may be heated by application of direct heat (e.g., steam, hot gas such as heated air or nitrogen) and/or application of indirect heat (e.g., a heat transfer fluid passed through a jacket surrounding the vessel). The vessel may operate at ambient pressure, vacuum pressure, and/or positive pressure at one or more stages during treatment.

Pretreatment unit 14 may heat the solid material to a temperature greater than 50° C., such as greater than 60° C., greater than 70° C., greater than 80° C., greater than 90° C., greater than 100° C., greater than 110° C., greater than 120° C., greater than 150° C., or greater than 175° C. For any one of these foregoing minimum heating temperatures, the maximum heating temperature may (but need not) be less than 200° C., such as less than 150° C., less than 125° C., or less than 100° C. For example, pretreatment unit 14 may heat the solid material to a temperature ranging from 60° C. to 150° C., such as from 70° C. to 125° C.

The humidity inside of the one or more vessels forming pretreatment unit 14 may be controlled to provide a controlled amount of moisture appropriate for deactivation of one or more ANFs of interest. For example, a humidity sensor may be installed on the vessel and communicatively coupled to an electronic controller that controls one or more features capable of adjusting the humidity level inside of the vessel. The electronic controller can control the humidity in response to the measurement signal from the humidity sensor. For example, the one or more vessels forming pretreatment unit 14 may be configured to inject water (e.g., liquid water, steam) into the vessel if additional moisture is desired. Additionally or alternatively, the one or more vessels may be connected to an atmospheric vent and/or source of gas having a comparatively low amount of moisture (e.g., atmospheric air, dried air, nitrogen) to reduce the level of moisture in the vessel. In practice, the amount of moisture with the incoming solid material may vary over time, location, the source of the incoming material, etc. As a result, pretreatment unit 14 may or may not need to increase and/or decrease the amount of moisture in the pretreatment unit during processing (e.g., depending on the amount of moisture in the incoming solid material). In either case, the moisture/humidity level may be controlled.

The moisture/humidity level inside the one or more vessels forming pretreatment unit 14 may be controlled to a minimum humidity level, a maximum humidity level, and/or within a target humidity range. In some implementations, pretreatment unit 14 controls the humidity to an absolute humidity of at least 0.01 g of water per gram of dry air, such as an absolute humidity of at least 0.025, at least 0.05, at least 0.1, at least 0.25, at least 0.5, at least 0.75, at least 1.0, or at least 1.25. Additionally or alternatively, pretreatment unit 14 may control the humidity to an absolute humidity of less than 2.0 g of water per gram of dry air, such as less than 1.75, less than 1.5, less than 1.25, less than 1.0, less than 0.75, less than 0.5, less than 0.25, or less than 0.01. For example, pretreatment unit 14 may control the humidity to a range from 0.01 to 1.5 g of water per gram of dry air, such as from 0.025 to 1.25, from 0.05 to 1.0, or from 0.1 to 0.75.

In some examples, pretreatment unit 14 introduces an amount of water into the solid material effective to increase the moisture concentration of the material by at least 0.5 weight percent, such as at least 1.0 weight percent, at least 2.0 weight percent, at least 3.0 weight percent, at least 5.0 weight percent, at least 10 weight percent, at least 15 weight percent, at least 20 weight percent, or at least 25 weight percent. For example, pretreatment unit 14 may introduce an amount of water into the material received by the unit to increases the moisture concentration of the material by an amount falling within a range from 1.0 weight percent to 30 weight percent, such as from 5.0 weight percent to 30 weight percent, from 10 weight percent to 30 weight percent, or from 20 weight percent to 30 weight percent.

The duration the solid material is treated at the select temperature and humidity may vary and, in some examples, is a period of at least one minute, such as at least two minutes, at least five minutes, at least 10 minutes, at least 15 minutes, at least 30 minutes, at least 45 minutes, or at least one hour. For example, the duration of treatment range from 15 minutes to two hours, such as from 30 minutes to one hour. The temperature and humidity may be substantially constant (e.g., ±10 percent) for the entire duration of treatment or one or both parameters may be controllably varied during the length of treatment.

One or more ANFs present in the incoming solid material to pretreatment unit 14 may be substantially completely deactivated by the pretreatment unit. The feed material supplied to pretreatment unit 14 may be processed before being introduced into the pretreatment unit. For example, depending on the material being processed, the material may be dehulled, ground (e.g., size reduced), and/or otherwise prepared for pretreatment. Additionally or alternatively, one or more of these processing steps may be performed after pretreatment. In either case, pretreated solid material (e.g., pretreated soy material in the case of a soy feedstock) produced by pretreatment unit 14 can be conveyed to extractor 12 for extraction.

In some implementations, the pretreated solid material is dried by dryer 18 before being extracted in extractor 12. Dryer 18 can reduce the amount of water in the pretreated solid material supplied to extractor 12. When using an alcohol-based solvent, the water content of the solid material introduced into the extractor may be controlled to prevent excess water from entering the extractor, which can dilute the solvent (e.g., reducing the effectiveness of the extraction and/or making solvent recovery challenging).

In the example of FIG. 1, extraction system 10 includes a dryer 18 to dry the solid feed material before the material is introduced into extractor 12. Dryer 18 may dry the material before and/or after size reduction and/or after other preprocessing (when performed in different implementations, dryer 18 may be and in direct dryer and/or a direct dryer. For example, dryer 18 may indirectly dry the pretreated solid material, e.g., by passing a thermal transfer fluid three jacketed drying vessel. Additionally or alternatively, dryer 18 may directly dry the pretreated solid material, e.g., by introducing a hot gas (e.g., dried air, nitrogen) into the solid material to pick up moisture and then venting the gas out of the vessel.

In general, dryer 18 may dry the pretreated solid material at a temperature effective to vaporize at least a portion of the moisture present in the material but also at a temperature not so hot as to damage the solid material (e.g., change the structure and/or degrade the nutritive properties of the material). In some implementations, dryer 18 dries the solid material at a temperature greater than 30° C., such as greater than 50° C., or greater than 60° C., greater than 70° C., greater than 80° C., or greater than 100° C. Additionally alternatively, dryer 18 may dry the solid material at a temperature less than 125° C., such as less than 100° C., or less than 80° C. For example, dryer 18 may dry the solid material at a temperature below the boiling point of water. In some examples, dryer 18 may dry the solid material at a temperature ranging from 40° C. to 90° C., such as from 50° C. to 80° C. Dryer 18 may typically operate at atmospheric pressure although, in other examples, may be configured to operate at a non-atmospheric pressure (e.g., vacuum pressure, positive pressure).

In some examples, the solid material being processed has a moisture content greater than five weight percent prior to pretreating via pretreatment unit 14, such as great than six weight percent, greater than seven weight percent, greater than eight weight percent, greater than nine weight percent, or greater than 10 weight percent. For example, the solid material have a moisture content ranging from five weight percent to 12 weight percent prior to pretreating via pretreatment unit 14.

Depending on the moisture content of the incoming solid material to pretreatment unit 14, the moisture content of the solid material may be increased, decreased, or remain substantially the same (e.g., ±10 weight percent) after pretreatment as compared to before pretreatment. As a result, the pretreated solid material supplied to dryer 18 may have a moisture content falling within any of the foregoing ranges described with respect to the solid material supplied to pretreatment unit 14.

In any case, dryer 18 can reduce the moisture content of the solid material. In some examples, dryer 18 is configured to dry the solid material to be processed to a moisture content of 5 weight percent or less, such as 3 weight percent or less, or 2 weight percent or less. Depending on the moisture content of the incoming solid material, dryer 18 may reduce the moisture content of the solid material by at least 0.5 weight percent, such as by at least one weight percent, by at least two weight percent, by at least three weight percent, by at least four weight percent, or by at least five weight percent.

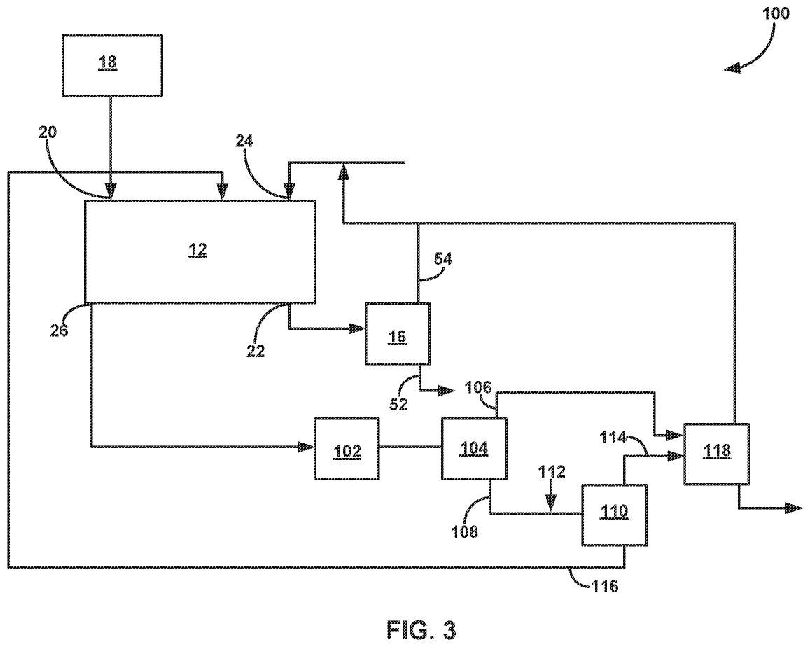

Extractor 12 can produce a solvent-wet solids stream that discharges through feed outlet 22 and a miscella stream that discharges through solvent outlet 26. The miscella stream may be further processed separate the solvent from the oil, an example process for which is discussed below in connection with FIG. 3. To recover solvent from the solvent-wet solids steam and further prepare the residual solids material for end use, the solvent-wet solids stream may be desolventized using mechanical and/or thermal desolventization devices. In the example of FIG. 1, system 10 includes a desolventizer 16. Desolventizer 16 can be implemented using one or more stages of mechanical and/or thermal treatment to remove solvent from the solvent-wet solids stream, thereby producing a dried extracted solid material (which may also be referred to as a desolventized extracted solid material). It should be appreciated that reference to a dried and/or desolventized solid material refers to a material that is comparatively dried and desolventized and does not require complete drying or desolventization or that the material be devoid of solvent. Rather, the material may be dried and desolventized to a practical level effective for downstream use and/or processing.

In some examples, desolventizer 16 heats the extracted solid material (the solvent-wet solids stream) produced by extractor 12 to vaporize solvent from the stream to produce a dried solid material. While desolventizer 16 may inject steam into the extracted solid material in some implementations, in other implementations, desolventizer 16 may desolventize the extracted solid material without adding moisture to the material during desolventizing. For example, desolventizer 16 may directly and/or indirectly heat the extracted solid material without injecting steam into the extracted solid material. Desolventizer 16 may indirectly heat the extracted solid material by passing a heat transfer fluid through a tray that the extracted material contacts while passing through a desolventizing vessel and/or through a jacket surrounding at least a portion of the desolventizing vessel. Additionally or alternatively, desolventizer 16 may introduce a heated gas substantially devoid of moisture (e.g., dried air, nitrogen) into an interior of the desolventizing vessel and extracted solid material therein.

Configuring desolventizer 16 to desolventize the extracted solid material without introducing additional moisture to the extracted solid material may be useful for subsequent solvent recovery. As discussed above, when using an alcohol solvent such as ethanol, the water and alcohol may form an azeotropic mixture that is challenging to separate for solvent recovery. Accordingly, desolventizing in the absence of added moisture may be useful in that the solvent vaporized by desolventizer 16 may have little or no water mixed with the alcohol that needs to be removed before the solvent can be recycled to extractor 12. Moreover, in implementations where one or more ANFs of interest are deactivated in pretreatment unit 14 prior to extraction, added moisture in the form of steam may not be needed during the desolventizing phase to deactivate the ANFs concurrent with desolventization.

In different examples, desolventizer 16 can be implemented using a cooker, jacketed paddle mixer, bulk solids heat exchanger, and/or desolventizer-toaster. In any case, the solvent separated from the solvent-wet extracted solids stream via desolventizer 16 can be recycled back to extractor 12 for reuse (optionally with further processing, such as to decrease the water content in the solvent stream, before being returned to the extractor).

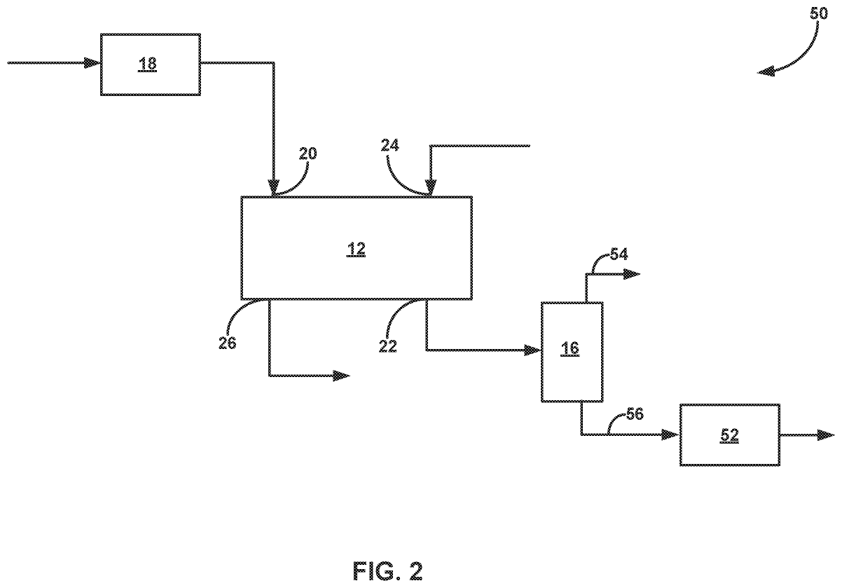

In the system of FIG. 1, the process of deactivating one on more ANFs of interest is separated from the desolventization process by pretreating the solid material prior to extraction. This allows the desolventization process to occur under different moisture conditions than the treatment process for deactivating the ANFs. FIG. 2 is a block diagram illustrating another example extraction system 50 according to the disclosure in which an extracted solid material is desolventized prior to deactivating one or more ANFs of interest.

In the example of FIG. 2, like reference numerals discussed above with respect to FIG. 1 refer to like components. Further, the example materials, compositions, and processing parameters (e.g., temperatures, pressures, moisture contents) discussed above with respect to FIG. 1 also apply to system 50 of FIG. 2 unless otherwise specified.

System 50 in FIG. 2 includes previously described extractor 12, desolventizer 16, and dryer 18. Unlike system 10 of FIG. 1 that includes pretreatment unit 14, system 50 is illustrated as including an ANF deactivation unit 52 downstream of desolventizer 16 (although, in other examples, may also include pretreatment unit 14). In operation of the system of FIG. 2, solid material to be processed may be optionally dried by dryer 18 and supplied to extractor 12. Extractor 12 can discharge a solvent-wet extracted solid material via feed outlet 22 after the solid material has undergone extraction in the extractor and has a lower concentration of extract than the fresh incoming material. Extractor 12 can also discharge a miscella formed via extraction of extractable components from the solid material via solvent outlet 26.

As discussed above with respect to FIG. 1, the solvent-wet extracted solid material discharged from extractor 12 via feed outlet 22 can be desolventized via desolventizer 16. Desolventizer 16 can produce a recovered solvent stream 54 and a desolventized extracted solid material 56. In the example of FIG. 2, the desolventized extracted solid material 56 is further processed in ANF deactivation unit 52 downstream of desolventizer 16. For example, in the system of FIG. 2, one or more ANFs of interest in the incoming solid material supplied to dryer 18 and/or extractor 12 may pass through the extractor 12 and desolventizer 16 (and drying 18, when used) without substantially reducing the concentration of one or more ANFs of interest. As a result, additional treatment of the downstream of desolventizer 16 by ANF deactivation unit 52 may be appropriate to deactivate one or more ANFs of interest in the solid material.

For example, the concentration of one or more ANFs of interest in desolventized extracted solid material 56 may be at least 50 weight percent of the concentration of the ANF(s) in the incoming solid material supplied to extractor 12 (and/or dryer 18), such as at least 70 weight percent, at least 80 weight percent, at least 90 weight percent, at least 95 weight percent, at least 98 weight percent, at least 99 weight percent, or at least 99.5 weight percent. According, processing performed upstream of ANF deactivation unit 52 may be insufficient to deactivate a majority of the concentration of one or more ANFs of interest in the solid material.

For example, desolventizer 16 can heat the extracted solid material (the solvent-wet solids stream) produced by extractor 12 to vaporize solvent from the stream to produce a dried solid material. While desolventizer 16 may inject steam into the extracted solid material, in other implementations, desolventizer 16 may desolventize the extracted solid material without adding moisture to the material during desolventizing. For example, desolventizer 16 may directly and/or indirectly heat the extracted solid material without injecting steam into the extracted solid material, as discussed above. Heating the extracted solid material in the absence of added moisture may be useful to prevent introducing additional water into the alcohol solvent. The water and alcohol can vaporize together to form recovered solvent stream 54, which can then make subsequent separation of the alcohol from the water challenging, particularly in the case of an azeotropic mixture. While heating the extracted solid material in the absence of added moisture may be useful to prevent introducing additional water into the alcohol solvent, these conditions may be insufficient to sufficiently deactivate one or more ANFs of interest in the solid material being processing.

ANF deactivation unit 52 may be configured and may operate under the conditions (e.g., temperature, moisture content, residence time) discussed as being suitable for pretreatment unit 14 in connection with FIG. 1. For example, ANF deactivation unit 52 may include one or more vessels that heat the solid material being processed at a controlled humidity. For example, ANF deactivation unit 52 may include a vessel that is pressure isolated from the ambient or surrounding environment.

In some implementations, for example, ANF deactivation unit 52 heats the desolventized extracted solid material 56 under controlled humidity conditions, which includes introducing water (e.g., steam) to the desolventized extracted solid material 56. The desolventized extracted solid material 56 received from desolventizer 16 may have a water content less than 5 weight percent, such as less than 2.5 weight percent, less than 2 weight percent, or less than 1.5 weight percent. For example, the moisture content of the desolventized extracted solid material 56 received from desolventizer 16 may range from 0.5 weight percent to 3 weight percent, such as from 1.0 weight percent to 2.5 weight percent.

ANF deactivation unit 52 may introduce water into the desolventized extracted solid material 56 received from desolventizer 16 to increase the moisture content of the solid material, e.g., to any of the absolute humidity values discussed above with respect to FIG. 1. In some examples, ANF deactivation unit 52 introduces an amount of water into the desolventized extracted solid material 56 received from desolventizer 16 effective to increase the moisture concentration of the material by at least 0.5 weight percent, such as at least 1.0 weight percent, at least 2.0 weight percent, at least 3.0 weight percent, at least 5.0 weight percent, at least 10 weight percent, at least 15 weight percent, at least 20 weight percent, or at least 25 weight percent. For example, ANF deactivation unit 52 may introduce an amount of water into the desolventized extracted solid material 56 received from desolventizer 16 that increases the moisture concentration of the material by an amount falling within a range from 1.0 weight percent to 30 weight percent, such as from 5.0 weight percent to 30 weight percent, from 10 weight percent to 30 weight percent, or from 20 weight percent to 30 weight percent.

Independent of whether ANF deactivation unit 52 introduces water into the desolventized extracted solid material 56 received from desolventizer 16, the ANF deactivation unit 52 can heat the material. ANF deactivation unit 52 can heat the material via indirect heating and/or direct heating (which may or may not involve adding steam to the material). In some examples, ANF deactivation unit 52 heats the desolventized extracted solid material 56 received from desolventizer 16 to a temperature greater than the temperature to which the extracted solid material was heated in desolventizer. For example, ANF deactivation unit 52 may heat the desolventized extracted solid material 56 to a temperature at least 5 degrees Celsius hotter greater than the temperature to which the extracted solid material was heated in desolventizer, such as at least 10 degrees Celsius hotter, at least 25 degrees Celsius hotter, at least 45 degrees Celsius hotter, at least 60 degrees Celsius hotter, or at least 75 degrees Celsius hotter. For example, ANF deactivation unit 52 may heat the desolventized extracted solid material 56 to a temperature from 25 degrees Celsius hotter to 85 degrees Celsius hotter than the temperature to which the extracted solid material was heated in desolventizer.

The recovered solvent stream 54 from desolventizer 16 can be recycled back to extractor 12 for reuse (optionally with further processing, such as to decrease the water content in the solvent stream, before being returned to the extractor). The desolventized extracted solid material 56 having undergone processing by ANF deactivation unit 52 may be discharged for downstream processing and/or use. ANF deactivation unit 52 may substantially completely deactivate all of one or more ANFs of interest in material received by the unit, including within the deactivation percentages discussed above with respect to pretreatment unit 14.

Independent of whether an extractor system includes pretreatment unit 14 and/or ANF deactivation unit 52, extractor 12 in the extractor system can produce a miscella stream that discharges through solvent outlet 26. Because the miscella stream contain solvent intermixed with extracted oil, the miscella stream may be further processed separate the solvent from the oil.

FIG. 3 is a block diagram illustrating an example extraction system 100 according to the disclosure in which a miscella stream is processed for solvent recovery. The features of exaction system 100 may or may not be implemented in combination with the features of extraction system 10 and/or 50 of FIGS. 1 and 2, respectively. However, for purposes of discussion, extraction system 100 will be described without reference to pretreatment unit 14 and/or ANF deactivation unit 52. In the example of FIG. 3, like reference numerals discussed above with respect to FIGS. 1 and/or 2 refer to like components. Further, the example materials, compositions, and processing parameters (e.g., temperatures, pressures, moisture contents) discussed above with respect to FIGS. 1 and/or 2 also apply to system 100 of FIG. 3 unless otherwise specified.

In the example of FIG. 3, extractor 12 produces a miscella stream that discharges through solvent outlet 26. This miscella stream can be further processed to help separate the oil faction of the miscella stream from the solvent fraction. In the example of FIG. 3, system 10 includes a cooling unit 102 that is configured to receive the miscella stream and cool the stream to promote liquid-liquid phase separation between the aqueous alcohol-based solvent component of the miscella and the extracted oil component of the miscella. Cooling unit 102 may be implemented using one or more heat exchangers or other thermal transfer devices that reduce a temperature of the miscella stream to a temperature effective to cause phase separation. In some examples, cooling unit 102 cools the miscella stream to a temperature less than 40 degrees Celsius, such as less than 30 degrees Celsius, or less than 25 degrees Celsius (e.g., a temperature ranging from 15 degrees Celsius to 25 degrees Celsius, such as approximately 20 degrees Celsius).

By contrast, the operating temperature of extractor 12 may be sufficiently hot to produce a miscella stream discharging from the extractor at a temperature greater than 50 degrees Celsius, such as greater than 60 degrees Celsius, or greater than 65 degrees Celsius. For example, the temperature of the miscella stream received from the extractor may range from 60 degrees Celsius to 90 degrees Celsius, such as from 65 degrees Celsius to 80 degrees Celsius, such as approximately 70 degrees Celsius.

Cooling the miscella stream can produce a first solvent-rich layer phase separated from a first oil-rich layer. A compositional gradient may exist between the solvent-rich layer and the oil-rich layer formed by cooling the miscella stream. In either case, in the example of FIG. 1, extraction system 10 includes a separator 104 to separate the first solvent-rich layer from the first oil-rich layer. Separator 104 may be implemented using a decanter (e.g., gravity decanter) and/or other liquid separation device, such as a centrifuge and/or cyclone. Separator 104 can separate the solvent-rich layer from the oil-rich layer to produce a separated first oil-rich layer/stream 106 and a separated first solvent-rich layer/stream 108. The two separate streams may be recycled and/or further processed.

For example, with reference to FIG. 3, the separated first solvent-rich stream 108 may be further processed with a secondary separator 110 to help remove residual oil from the stream. A secondary separation can be performed on the first separated solvent-rich stream to form a separated solvent stream and a second separated oil-rich stream. Secondary separator 110 may be, or include, one or more separation devices configured to further separate residual oil from the solvent in the first solvent-rich stream 108. In some implementations, secondary separator 110 includes a mechanical separation device, such as a centrifuge and/or a cyclone. Additionally or alternatively, secondary separator 110 may be configured to promote flocculation of the oil and/or solvent factions in separated first solvent-rich stream 108 to promote further separation of the two fractions.

For example, in the example of FIG. 3, extraction system 100 is configured so an amount of water 112 is added to the separated first separated solvent-rich stream 108 to promote further phase separation between the oil component of the stream and the solvent component in the stream. The amount of water added to the first separated solvent-rich stream 108 may be comparatively small, such as an amount of water that is less than 10 weight % of a weight of the separated first separated solvent-rich stream 108, such as less than 5 weight %, less than 3 weight %, less than about 1 weight %, less than about 0.5 weight %, less than about 0.2 weight %, or less than about 0.1 weight %. In some examples, mixing equipment such as a static mixer, dynamic mixer, and/or homogenizer may be used to facilitate mass transfer between the phases and promote further phase separation.

Adding an amount of water to the separated first separated solvent-rich stream 108 can cause further liquid-liquid phase separation between the oil component in the stream and the solvent component (e.g., alcohol) in the stream. This can form a second solvent-rich layer phase separated from a second oil-rich layer. A compositional gradient may exist between the solvent-rich layer and the oil-rich layer formed by adding water to the first separated oil-rich stream.

In addition to or in lieu of adding water to promote further separation of the first separated solvent-rich stream 108, the secondary separator may further cool the first separated solvent-rich stream. For example, secondary separator 110 may cool the first separated solvent-rich stream 108 to a temperature less than a temperature to which the miscella by cooling unit 102. In these implementations, secondary separator 110 may includes one or more heat exchangers or other thermal transfer devices that reduce a temperature of the first separated solvent-rich stream 108. In some examples, secondary separator 110 reduces the temperature of the first separated solvent-rich stream 108 to a temperature at least 5 degrees Celsius less than a temperature to which the miscella stream was cooled by cooling unit 102, such as a temperature at least 10 degrees Celsius less, at least 15 degrees Celsius less, at least 20 degrees Celsius less, or at least 25 degrees Celsius less. The cooling may promote phase separation between the aqueous solvent and the oil fractions.

In either case, in the example of FIG. 3, extraction system 100 includes a second separator to separate the second solvent-rich layer from the second oil-rich layer. The separator (e.g., secondary separator 110) may be implemented using a decanter (e.g., gravity decanter) and/or other liquid separation device, such as a centrifuge and/or cyclone. Separator 110 can separate the solvent-rich layer from the oil-rich layer to produce a separated second oil-rich stream 114 and a separated second solvent-rich stream 116, which may also be referred to as a separated solvent stream. The two separate streams may be recycled and/or further processed.

In the example of FIG. 3, extraction system 100 includes thermal separator 118. Thermal separator 118 can receive separated first oil-rich stream 106 and/or separated second oil-rich stream 114 produced by secondary separator 110 to remove residual solvent from one or both streams. Thermal separator 118 can be implemented using a stripping column (e.g., that utilizes steam or other motive gas), a distillation column, a flash drum, and/or other thermal separation device. In either case, the solvent separated from the separated first oil-rich stream 106 and/or separated second oil-rich stream 114 via thermal separator 118 can be recycled back to solvent inlet 24 of extractor 12 for reuse.

The separated solvent stream 116 produced by secondary separator 110 can be recycled to extractor 12 and/or reused. In different examples, the separated solvent stream 116 can be recycled to inlet 24 of extractor 12 or to a location different than a location where fresh solvent is introduced into the extractor. For example, the separated solvent stream 116 may be recycled to extractor 12 and introduced into the extractor at an earlier extraction stage than an extraction stage where fresh solvent is introduced into the extractor. For example, the separated solvent stream 116 may be recycled back to extractor 12 and introduced into the extractor at a location where a composition of miscella in the extractor is substantially the same as a composition of the first separated solvent-rich stream. For example, the concentration of the solvent in the separated solvent stream 116 (calculated by dividing the weight of the alcohol and water by the combined weight of the alcohol, water, and oil) may be within ±20 weight percent of the concentration of the solvent in the miscella in the extraction stage of the extractor to which the separated solvent stream is recycled, such as within ±10 weight percent, or within ±5 weight percent.

Extractor 12 in any of the foregoing examples can be implemented using any suitable type of extractor configuration. For example, extractor 12 may be an immersion extractor, a percolation extractor, or yet other type of extractor design. In one example, extractor 12 is a shallow bed continuous loop extractor.

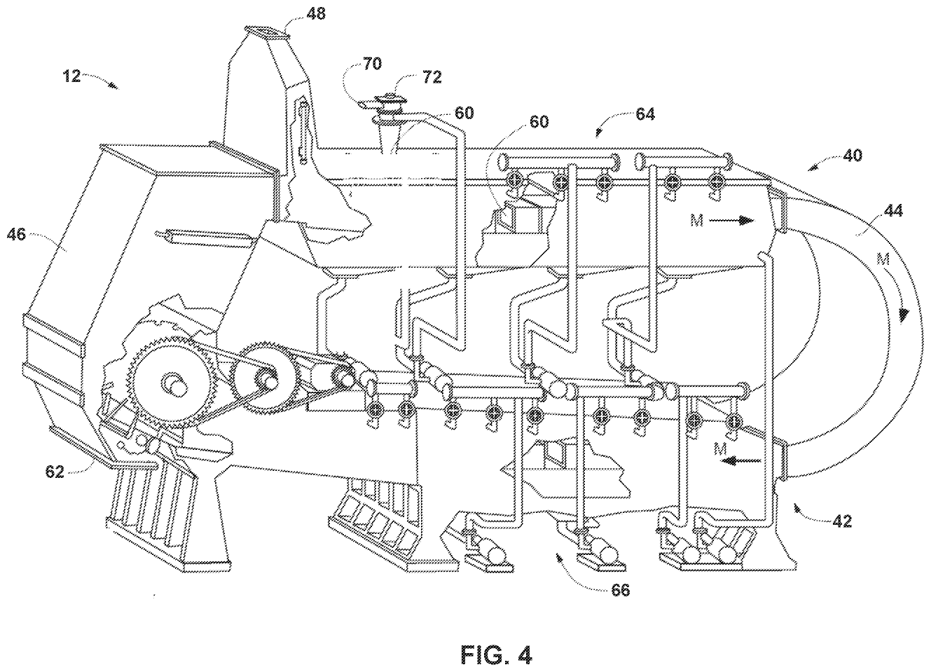

FIG. 4 is an illustration of an example extractor configuration that can be used for extractor 12. In the example shown, extractor 12 includes a housing defining a passageway in the form of a loop disposed in a vertical plane. The extractor can include upper and lower extraction sections 40, 42 each with a series of extraction chambers, a generally arcuate hollow transfer section 44 having its opposite upper and lower ends connected to first ends of the upper and lower extraction sections respectively, and a hollow, generally vertical return section 46 connected at its upper and lower ends respectively to the other ends of the upper and lower extraction sections. The upper extraction section can include an inlet portion 48 for delivery of solid material to the interior thereof in closely spaced relation to the upper end of the return section, and the lower end of the return section can define an opening 62 for discharge of the material after the product-of-interest has been extracted therefrom. The number of extraction chambers, or stages, provided by the extractor can vary depending on the desired sized of the extractor. The extractor includes at least one extraction chamber, or stage, and typically includes multiple stages (e.g., 6 stages, 8 stages, or more). A Model III extractor commercially available from Crown Iron Works Company of Minneapolis, MN, is a specific example of an extractor of this type.

In such an extractor, a conveyor system 60 can extend longitudinally through the looped passageway and be driven in a material flow direction “M” to move the material as a bed from the inlet portion 48 through the upper extraction section 40 toward and downwardly through the transfer section 44, and through the lower extraction section 42 toward the lower end of the return section and the discharge opening 62. In some embodiments, the conveyor system includes a pair of laterally spaced endless link chains and a plurality of longitudinally spaced flights that extend transversely of the chains. A motor and gearing may be provided to drive the conveyor.

In some configurations, a fluid supply system 64 can be disposed above the solid materials and configured to apply a fluid to the solid materials in each extraction chamber, and a fluid removal system 66 can be disposed below the solid materials and configured for removing the fluid after it has passed through the solid materials in each extraction chamber. In some embodiments, the fluid supply system and the fluid removal system are in fluid communication via various recycle streams and the like. The fluid supply system may include a network of spray headers, pumps, and pipes to apply the fluid in each extraction chamber. The fluid supply system can apply (e.g., spray) the extraction fluid on top of the conveyed solid material, allowing the extraction fluid to then percolate through the material. The fluid removal system may include a network of drains, pumps, and pipes to collect the fluid after it has percolated through the solid material in each extraction chamber and deliver it to the fluid supply system of another extraction chamber or remove it from the system.

As shown in FIG. 4, fluid having passed through the solid material is collected by the fluid removal system 66 and delivered to a separation device 68, which in the illustrated example is shown as a cyclone-type separator to separate any solid fines from the fluid before fluid discharge. An outlet conduit 70 of separation device 68 can deliver the fluid, generally a mixture of extraction fluid and soluble components extracted from the solid material into the extraction fluid (e.g., oil when processing oil seed) (commonly known as “miscella”), to other equipment, not shown, for separating the extraction fluid from the material extracted from the solid material being processed. A separate outlet 72 of separation device 68 can deliver a stream containing particulate matter separated from the miscella for further processing, as described herein.

As material is conveyed through extractor 12, spray headers from the fluid supply system 64 spray recycled extraction fluid on the top of the material. The material percolates through the material and through the screen, where it is collected in the network of drain pipes and delivered back to the network of spray headers where it is reapplied to the solid material in a different extraction chamber. In some embodiments, fresh extraction fluid is applied to the material in the last extraction chamber before the solid material discharge 62. For example, fresh extraction fluid may be applied to the material in the last extraction chamber before discharge 62 and, after being collected at the bottom of the chamber, recycled and applied on top of solid material in an adjacent upstream extraction chamber. By recycling collected extraction fluid from one extraction chamber to an adjacent upstream extraction chamber, liquid extraction fluid and solid material being processed can move in countercurrent directions through the extractor. For example, as extraction fluid is conveyed sequentially through adjacent extraction chambers between a fresh extraction fluid inlet adjacent discharge 62 and an enriched extraction fluid outlet adjacent inlet 48, the concentration of extract relative to extraction fluid increases from a relatively small extract-to-extraction fluid ratio to a comparatively large extract-to-extraction fluid ratio. Similarly, as the solid material is conveyed in the opposing direction, the concentration of extract in the solid feedstock decreases from a comparatively high concentration at the inlet 48 to a comparatively low concentration at the outlet 62.

An alcohol-based solvent extraction process according to the present disclosure may provide various advantages over an extraction process that does not use an alcohol-based solvent. For example, an alcohol-based solvent may provide better compatibility with food supply chains. Ethanol is GRAS (Generally Recognized As Safe), can be produced organically from renewable feedstocks, and is already consumed directly as a component of alcoholic beverages. As another example, an alcohol-based solvent may improve the processed product attributes of some feedstocks. When applied to soybean flakes, for instance, an alcohol-based solvent may produce a meal with less “beany” flavor and less color. When applied to either soybean flakes or cottonseed meats, an alcohol-based solvent may alter protein solubility and lower antinutritional factor content. The alcohol-based solvent may produce an oil with lower wax and phosphatide content.

Various examples have been described. These and other examples are within the scope of the following claims.

1. A method comprising:
pretreating a soy material containing a trypsin inhibitor to deactivate the trypsin inhibitor, thereby forming a pretreated soy material;
conveying the pretreated soy material in a conveyance direction through an extractor and conveying a solvent comprising alcohol in a countercurrent direction from the conveyance direction through the extractor, thereby generating an extracted soy material stream and a miscella stream;
separating the solvent from the miscella stream, thereby forming an extracted oil stream; and
desolventizing the extracted soy material stream, thereby formed a dried extracted soy material stream.

2. The method of claim 1, wherein pretreating the soy material containing the trypsin inhibitor comprises heating the soy material under controlled humidity.

3. The method of claim 1, wherein pretreating the soy material containing the trypsin inhibitor comprises heating the soy material to a temperature ranging from 70 degrees Celsius to 125 degrees Celsius, at an absolute humidity ranging from 0.05 grams of water per gram of dry air to 1.0 grams of water per gram of dry air, for a period of at least 30 minutes.

4. The method of claim 1, further comprising, after pretreating the soy material and prior to conveying the pretreated soy material through the extractor, drying the pretreated soy material.

5. The method of claim 4, wherein drying the pretreated soy material comprises drying the pretreated soy material at a temperature ranging from 50 degrees Celsius to 80 degrees Celsius.

6. (canceled)

7. (canceled)

8. The method of claim 1, wherein pretreating the soy material comprises conveying the soy material through a vessel pressure isolated from an ambient environment at a controlled temperature and a controlled humidity.

9. The method of claim 1, wherein desolventizing the extracted soy material stream comprises desolventizing the extracted soy material stream without injecting steam into the extracted soy material stream.

10. The method of claim 1, wherein desolventizing the extracted soy material stream comprises desolventizing the extracted soy material stream in a desolventizer that indirectly heats that the extracted soy material stream.

11. The method of claim 1, wherein the alcohol comprises ethanol.

12. (canceled)

13. (canceled)

14. A method comprising:
conveying a material to be processed in a conveyance direction through an extractor and conveying a solvent comprising alcohol in a countercurrent direction from the conveyance direction through the extractor, thereby generating an extracted material stream and a miscella stream;
cooling the miscella stream to form a first solvent-rich layer phase separated from a first oil-rich layer;
separating the first solvent-rich layer from the first oil-rich layer to form a first separated oil-rich stream and a first separated solvent-rich stream;
performing a secondary separation on the first separated solvent-rich stream to form a separated solvent stream and a second separated oil-rich stream; and
recycling the separated solvent stream back to the extractor.

15. The method of claim 14, wherein the secondary separation comprises at passing the first separated solvent-rich stream through at least one of a centrifuge and a cyclone.

16. The method of claim 14, wherein the secondary separating comprises:
introducing water into the first separated solvent-rich stream; and
separating the separated solvent stream from the second separated oil-rich oil stream.

17. The method of claim 14, wherein the secondary separation comprises:
cooling the first separated solvent-rich stream to a temperature less than a temperature to which the miscella stream was cooled, and
separating the separated solvent stream from the second separated oil-rich oil stream.

18. (canceled)

19. (canceled)

20. The method of claim 14, further comprising:
conveying at least the first separated oil-rich stream to a thermal separator and thermally separating residual solvent in the first separated oil-rich stream from oil, thereby forming a thermally separated solvent stream and an oil stream; and
recycling the thermally separated solvent stream back to the extractor and introducing the thermally separated solvent stream with the separated solvent stream recycled to the extractor.

21. (canceled)

22. The method of claim 20, wherein the thermal separator comprises a flash drum followed by a stripping column, and thermally separating residual solvent in the first separated oil-rich stream from oil comprises:
flashing the first separated oil-rich stream to form a first thermally separated solvent stream and a first oil stream, and
stripping the first oil stream to form a second thermally separated solvent stream and a second oil stream.

23. The method of claim 22, further comprising recycling the first thermally separated solvent stream and the second thermally separated solvent stream back to the extractor and introducing the first and second thermally separated solvent streams with the separated solvent stream recycled to the extractor.

24-26. (canceled)

27. The method of claim 14, wherein the alcohol comprises ethanol.

28-33. (canceled)

34. A method comprising:
conveying a soy material in a conveyance direction through an extractor and conveying a solvent comprising alcohol in a countercurrent direction from the conveyance direction through the extractor, thereby generating an extracted soy material stream and a miscella stream;
separating the solvent from the miscella stream, thereby forming an extracted oil stream and an extracted soy material stream;
desolventizing the extracted soy material stream in an absence of added moisture during desolventizing, thereby forming a recovered solvent stream and a desolventized extracted soy material; and
deactivating a trypsin inhibitor in the desolventized extracted soy material.

35. The method of claim 34, wherein desolventizing the extracted soy material stream comprises desolventizing the extracted soy material stream in a desolventizer that indirectly heats that the extracted soy material stream.

36. (canceled)

37. The method of claim 34, wherein the extracted soy material stream has a moisture content of less than 2.5 weight percent, and desolventizing the extracted soy material stream comprises heating the extracted soy material stream to a temperature greater than 60 degrees Celsius.

38. (canceled)

39. The method of claim 34, wherein deactivating the trypsin inhibitor in the desolventized extracted soy material comprises heating the desolventized extracted soy material under controlled humidity.

40. The method of claim 39, wherein deactivating the trypsin inhibitor in the desolventized extracted soy material comprises heating the desolventized extracted soy material a temperature ranging from 70 degrees Celsius to 125 degrees Celsius, at a humidity ranging from 0.05 grams of water per gram of dry air to 1.0 grams of water per gram of dry air, for a period of at least 30 minutes.

41. The method of claim 39, wherein deactivating the trypsin inhibitor in the desolventized extracted soy material comprises introducing steam into the desolventized extracted soy material.

42. The method of claim 39, wherein heating the desolventized extracted soy material comprises heating the desolventized extracted soy material to a temperature higher than a temperature to which the extracted soy material stream is heated during desolventizing.

43-45. (canceled)

46. The method of claim 34, wherein the alcohol comprises ethanol.

47-49. (canceled)
